(19) United States
(12) Patent Application Publication
(10) Pub. No.: US 2026/0210160 A1
(43) Pub. Date: Jul. 23, 2026

(54) VEHICLE DOOR LOCK AND VEHICLE

(71) Applicant: BYD COMPANY LIMITED, Shenzhen (CN)

(72) Inventors: Feixiang DING, Shenzhen (CN); Xuebo GUO, Shenzhen (CN); Xijing GONG, Shenzhen (CN); Qinhan WANG, Shenzhen (CN); Jiangwei MENG, Shenzhen (CN)

(21) Appl. No.: 19/578,029

(22) Filed: Mar. 25, 2026

Related U.S. Application Data
(63) Continuation of application No. PCT/CN2024/079224, filed on Feb. 29, 2024.

(30) Foreign Application Priority Data
Sep. 26, 2023 (CN) 202322651567.2

(51) Int. Cl. E05B 77/26; E05B 81/06; E05B 81/16; E05B 81/30

(52) U.S. Cl. CPC E05B 77/26; E05B 81/06; E05B 81/16; E05B 81/30

(57) ABSTRACT

A vehicle door lock includes a first rocker arm, a sliding member, a connecting arm and a cooperating rocker arm; the first rocker arm and the connecting arm are connected via the sliding member; the first rocker arm includes a first driving slot and a first clearance slot; the sliding member is provided with a connecting post; the cooperating rocker arm has a locked state and an unlocked state. When the connecting post is inserted through the connecting arm and the first driving slot, the first rocker arm is configured to drive the connecting arm to rotate via the connecting post, and the cooperating rocker arm is switched from the locked state to the unlocked state. When the connecting post passes through the connecting arm and the first clearance slot, the cooperating rocker arm is configured to be kept in the locked state when the first rocker arm moves.

### CROSS-REFERENCE TO RELATED APPLICATIONS

The present disclosure is a bypass continuation of International Patent Application No. PCT/CN2024/079224, filed Feb. 2, 2024, which claims priority to Chinese Patent Application No. 202322651567.2, filed on Sep. 26, 2023, entitled “Vehicle Door Lock and Vehicle”, the entire content of both of which are hereby incorporated into the present disclosure by reference for all purposes.

### FIELD

The present disclosure relates to the technical field of automotive components and, in particular, to a vehicle door lock and a vehicle.

### BACKGROUND

With the development of economy and progress of science and technology, vehicles have become an indispensable means of transportation for people, and vehicle door lock devices have become increasingly mature. With the rapid and diversified development of the vehicle industry, users have put forward higher requirements for the functional diversity and reliability of vehicle door locks.

In the related art, if the inner opening handle is pulled by mistake, the vehicle door lock may be opened, which is likely to cause accidents. When the vehicle is running, the driver is operating the vehicle from the driver's seat and cannot take into account the situation of rear-seat passengers. When the rear-seat passengers include children or the elderly, there is a risk that the inner opening handle may be pulled by mistake, which may lead to inadvertent door opening, potentially resulting in personal injury.

### SUMMARY

In various aspects, the present disclosure provides a vehicle door lock and a vehicle that addresses the problem of inadvertent door opening by passengers, thereby improving safety and protecting the safety of passengers in the vehicle.

In a first aspect, the present disclosure provides a vehicle door lock, the vehicle door lock includes a first rocker arm, a sliding member, a connecting arm and a cooperating rocker arm; the first rocker arm, the connecting arm and the sliding member are successively stacked; the first rocker arm and the connecting arm are connected via the sliding member; the first rocker arm is provided with a first driving slot and a first clearance slot, the first driving slot and the first clearance slot communicate with each other; the sliding member is provided with a connecting post; the cooperating rocker arm has a locked state and an unlocked state. When the connecting post is inserted through the connecting arm and the first driving slot, the first rocker arm is fixedly connected to the connecting arm, and the first rocker arm is configured to drive the connecting arm to rotate via the connecting post, the connecting arm abuts against the cooperating rocker arm, and the cooperating rocker arm is switched from the locked state to the unlocked state. When the connecting post is inserted through the connecting arm and the first clearance slot, the fixed connection between the first rocker arm and the connecting arm is released such that, when the first rocker arm moves, the cooperating rocker arm is configured to be kept in the locked state.

In some embodiments, the connecting arm is provided with a first elongated hole, the first elongated hole penetrates through the connecting arm, the connecting post is arranged along the thickness direction of the sliding member; while the connecting post moves within a long axis of the first elongated hole, the connecting post simultaneously moves into the first driving slot or the first clearance slot.

In some embodiments, the vehicle door lock further includes a toggle, the toggle is arranged on a side of the sliding member away from the connecting arm, and the toggle is slidably and rotatably connected with the sliding member; the toggle is configured to drive the sliding member to move, such that the connecting post moves into the first driving slot or the first clearance slot.

In some embodiments, the vehicle door lock further includes an inner opening rocker arm, the inner opening rocker arm abuts against the first rocker arm, the inner opening rocker arm is configured to connect to an inner opening handle of a vehicle, wherein the inner opening handle is configured to drive the inner opening rocker arm to rotate such that the inner opening rocker arm drives the first rocker arm to rotate.

In some embodiments, the vehicle door lock further includes a second rocker arm, a locking pin and a locking linkage, the second rocker arm is arranged on a side of the first rocker arm away from the connecting arm, and the locking pin is rotatably and slidably connected between the first rocker arm and the second rocker arm; the first rocker arm is further provided with a second driving slot and a second clearance slot, the second driving slot and the second clearance slot communicate with each other, and the second driving slot and the second clearance slot are spaced apart from the first driving slot and the first clearance slot; the locking linkage is provided with a locked position and an unlocked position. When the locking pin is inserted between the second driving slot and the second rocker arm, the first rocker arm is fixedly connected to the second rocker arm, the first rocker arm can drive the second rocker arm to rotate via the locking pin such that the second rocker arm abuts against the locking linkage, and the locking linkage is switched from the locked position to the unlocked position. When the locking pin is inserted between the second clearance slot and the second rocker arm, the fixed connection between the first rocker arm and the second rocker arm is released such that, when the first rocker arm moves, the locking linkage is configured to be kept in the locked position.

In some embodiments, the second rocker arm is provided with a second elongated hole, one end of the locking pin is inserted through the second elongated hole, one end of the locking pin is configured to move within a long axis of the second elongated hole, and the other end of the locking pin moves into the second driving slot or the second clearance slot.

In some embodiments, the vehicle door lock further includes a first drive assembly, the first drive assembly is configured to drive the locking pin to move into the second driving slot or the second clearance slot.

In some embodiments, the first drive assembly includes a first drive member, a first transmission member and a lock body slider, the first transmission member is rotatably connected between the first drive member and the lock body slider, and the lock body slider is rotatably and slidably connected with the locking pin, the first drive member is configured to drive the first transmission member to rotate, the rotation of the first transmission member is configured to drive the lock body slider to move, and the lock body slider drives the locking pin to move into the second driving slot or the second clearance slot.

In some embodiments, the vehicle door lock further includes a second drive assembly, the second drive assembly is configured to drive the locking linkage to switch between the unlocked position and the locked position.

In some embodiments, the second drive assembly further includes a second drive member and a second transmission member, the second drive member is rotatably connected with the second transmission member, and the second transmission member is fixedly connected to the locking linkage, the second drive member is operable to drive the second transmission member and the locking linkage to rotate together such that the locking linkage is operable to switch between the unlocked position and the locked position.

In a second aspect, the present disclosure also provides a vehicle, the vehicle includes a vehicle door and a vehicle door lock according to any one of the various embodiments of the first aspect, and the vehicle door lock is installed on the vehicle door.

According to the vehicle door lock provided by the present disclosure, when the connecting post is inserted through the connecting arm and the first driving slot, the first rocker arm is fixedly connected to the connecting arm, the first rocker arm can drive the connecting arm to rotate via the connecting post, the connecting arm abuts against the cooperating rocker arm, and the cooperating rocker arm is switched from the locked state to the unlocked state, and the inner door handle can be driven to open the vehicle door. When the connecting post is inserted through the connecting arm and the first clearance slot, the fixed connection between the first rocker arm and the connecting arm is released such that, when the first rocker arm moves, the cooperating rocker arm is configured to be kept in the locked state, and the inner door handle cannot be driven to open the door, which can prevent the door from being opened by mistake and protect the safety of passengers in the vehicle.

### BRIEF DESCRIPTION OF THE DRAWINGS

In order to illustrate the technical solutions in the embodiments of the present disclosure more clearly, the accompanying drawings for describing the embodiments will be briefly introduced below. It will be apparent that the drawings in the following description are merely some embodiments of the present disclosure, for a person skilled in the art, other drawings may be derived from these accompanying drawings without any creative effort.

FIG. 1 is a schematic structural diagram of a vehicle door lock in an embodiment of the present disclosure;

FIG. 2 is a three-dimensional exploded schematic diagram of the vehicle door lock in FIG. 1;

FIG. 3 is a partial enlarged view of the vehicle door lock in FIG. 1 from another perspective;

FIG. 4 is a three-dimensional structural schematic diagram of a first rocker arm of the vehicle door lock in FIG. 1;

FIG. 5 is a three-dimensional exploded schematic diagram of a vehicle door lock in an embodiment of the present disclosure.

### DETAILED DESCRIPTION

The technical solutions in the embodiments of the present disclosure will be clearly and completely described below in conjunction with the accompanying drawings. It will be apparent that the described embodiments are merely part of, rather than all of, the embodiments of the present disclosure. All other embodiments obtained by a person skilled in the art based on the embodiments in the present disclosure without creative efforts shall fall within the scope of protection of the present disclosure.

It should be noted that when a component is referred to as being “fixed to” another component, it may be directly fixed on the other component or there may also be an intermediate component. When a component is considered to be “connected” to another component, it may be directly connected to the other component or there may be an intermediate component.

Unless otherwise defined, all technical and scientific terms used in the present disclosure have the same meaning as commonly understood by a person skilled in the technical field to which this disclosure pertains. The terms used in the specification of the present disclosure are only for the purpose of describing specific embodiments, and are not intended to limit the scope of the present disclosure. The term “and/or” used in the present disclosure comprises any and all combinations of one or more of the associated listed items.

Some embodiments of the present disclosure will be described in detail below in conjunction with the accompanying drawings. In the case of no conflict, the following embodiments and features in the embodiments can be combined with each other.

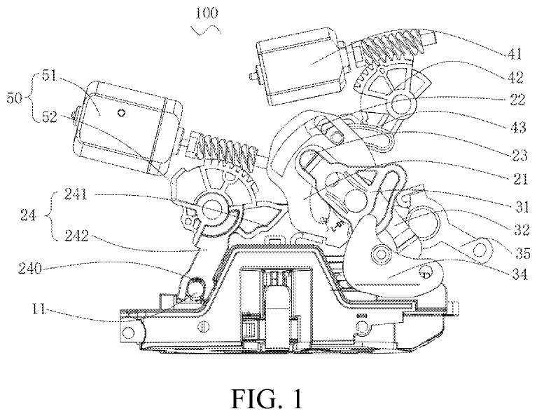

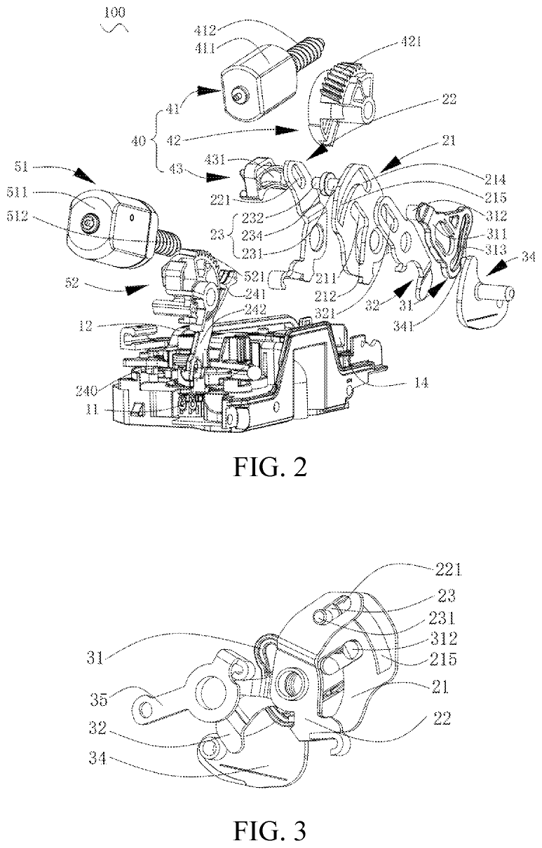

FIG. 1 is a schematic structural diagram of a vehicle door lock in an embodiment of the present disclosure. FIG. 2 is a three-dimensional exploded schematic diagram of the vehicle door lock in FIG. 1. As shown in FIG. 1 and FIG. 2, the present disclosure provides a vehicle, the vehicle comprises a vehicle door and a vehicle door lock 100, the vehicle door lock 100 is installed on the vehicle door, and the vehicle door lock 100 is fastened to the vehicle door by bolts. The vehicle door lock 100 provided by the embodiment of the present disclosure is applied to a vehicle, and the vehicle can specifically be a fuel vehicle or a new energy electric vehicle. The vehicle door lock 100 can help the vehicle realize the functions of opening and locking the vehicle door.

The vehicle door lock 100 comprises a linkage structure 11, a push rod 12, a locking arm and a latch. The linkage structure 11 pulls the push rod 12, the push rod 12 can abut against the locking arm, and the locking arm can be clamped with the latch. The linkage structure 11 has an unlocked position and a locked position and a user can drive the linkage structure 11 to switch to the unlocked position or the locked position via a vehicle key, a remote control or other suitable ways. When the linkage structure 11 switches from the unlocked position to the locked position, the linkage structure 11 pulls the push rod 12 to move, the abutting relationship between the push rod 12 and the locking arm is released, and the locking arm is clamped with the latch such that the user cannot open the vehicle door by driving the inner opening handle or the outer opening handle. When the linkage structure 11 switches from the locked position to the unlocked position, the linkage structure 11 pulls the push rod 12 to move in the opposite direction such that the push rod 12 abuts against the locking arm, and the locking arm disengages from the latch to allow the user to open the vehicle door by driving the inner opening handle or the outer opening handle.

The vehicle door lock 100 further comprises an outer opening rocker arm and a cooperating rocker arm 14. The outer opening rocker arm is connected to the outer opening handle of the vehicle, and the outer opening rocker arm is connected to the cooperating rocker arm 14 via a pivot pin. When the linkage structure 11 is in the unlocked position, the user drives the outer opening handle, the outer opening handle drives the outer opening rocker arm to rotate, the outer opening rocker arm drives the cooperating rocker arm 14 to rotate, the cooperating rocker arm 14 is switched from the locked state to the unlocked state, the cooperating rocker arm 14 drives the push rod 12 to rotate such that the push rod 12 abuts against the locking arm, and the locking arm is disengaged from the latch, thereby opening the vehicle door.

The vehicle door lock 100 further comprises an inner opening rocker arm 35, a first rocker arm 21, a connecting arm 32 and a sliding member 31. The inner opening rocker arm 35 is configured to be connected to an inner opening handle of a vehicle, the inner opening rocker arm 35 abuts against the first rocker arm 21, the first rocker arm 21 abuts against the connecting arm 32 via the sliding member 31, and the connecting arm 32 abuts against the inner opening rocker arm 35. When the linkage structure 11 is in the unlocked position, if the user drives the inner opening handle, then the inner opening handle drives the inner opening rocker arm 35 to rotate, the inner opening rocker arm 35 drives the first rocker arm 21 to rotate, the first rocker arm 21 drives the connecting arm 32 to rotate via the sliding member 31, the connecting arm 32 drives the cooperating rocker arm 14 to rotate, the cooperating rocker arm 14 is switched from the locked state to the unlocked state, the cooperating rocker arm 14 drives the push rod 12 to rotate such that the push rod 12 abuts against the locking arm, and the locking arm is disengaged from the latch, thereby opening the vehicle door.

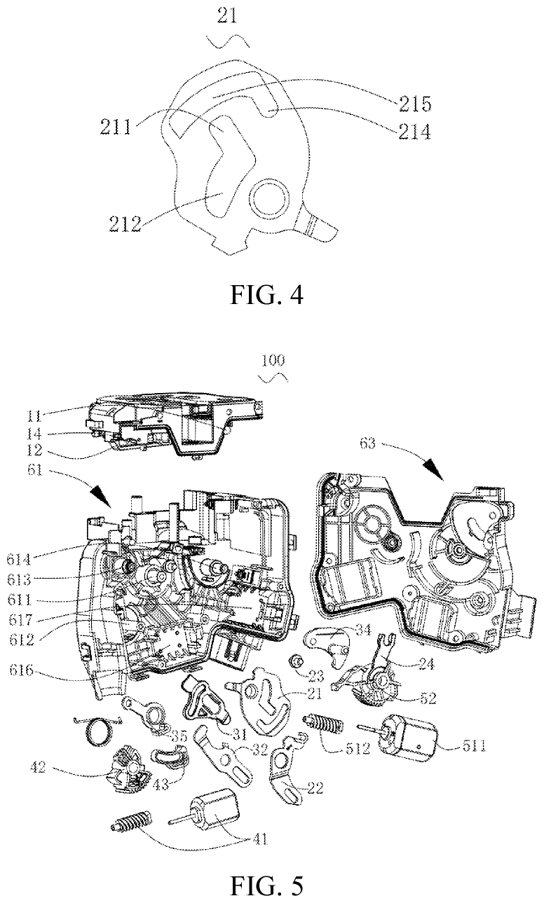

Referring now to FIG. 3 and FIG. 4, FIG. 3 is a partial enlarged view of the vehicle door lock in FIG. 1 from another perspective, and FIG. 4 is a three-dimensional structural schematic diagram of a first rocker arm of the vehicle door lock in FIG. 1. As shown in FIG. 3 and FIG. 4, the first rocker arm 21, the connecting arm 32 and the sliding member 31 are successively stacked, and the first rocker arm 21 and the connecting arm 32 are connected via the sliding member 31. The first rocker arm 21 is provided with a first driving slot 211 and a first clearance slot 212, the connecting post 312 can pass through the first driving slot 211 and the first clearance slot 212, the first driving slot 211 and the first clearance slot 212 extend through the first rocker arm 21, and the first driving slot 211 and the first clearance slot 212 communicate with each other. The first driving slot 211 and the first clearance slot 212 are L-shaped, the first driving slot 211 is arranged above the first clearance slot 212. Alternatively, the first driving slot 211 can also be arranged below the first clearance slot 212, which is not limited here. The joint of the first driving slot 211 and the first clearance slot 212 is a smooth transition to facilitate smooth sliding of the connecting post 312 between the first driving slot 211 and the first clearance slot 212. In other embodiments, the first driving slot 211 and the first clearance slot 212 are formed on the surface of the first rocker arm 21 facing the connecting arm 32, and the first driving slot 211 and the first clearance slot 212 do not extend through the first rocker arm 21, which can also realize the sliding connection of the connecting post 312 with the first rocker arm 21.

The connecting arm 32 is provided with a first elongated hole 321, the first elongated hole 321 penetrates through the connecting arm 32, the first driving slot 211 and at least part of the first clearance slot 212 are opposite to the first elongated hole 321. The connecting post 312 passes through the first elongated hole 321, and the connecting post 312 can move along the long axis of the first elongated hole 321.

The sliding member 31 comprises a connecting piece 311 and a connecting post 312 connected to the connecting piece 311, the connecting piece 311 has a sheet-like structure, and the connecting post 312 has a columnar structure. The connecting post 312 is connected to a side wall of the connecting piece 311 facing the connecting arm 32 along the thickness direction of the connecting piece 311, the connecting post 312 passes through the first driving slot 211 (or the first clearance slot 212) of the first rocker arm 21 and the first elongated hole 321 of the connecting arm 32.

When the connecting post 312 is inserted through the first driving slot 211 and the first elongated hole 321, the first rocker arm 21 is driven to rotate, the first rocker arm 21 is fixedly connected to the connecting arm 32 via the connecting post 312, the first rocker arm 21 drives the connecting arm 32 to rotate, the connecting arm 32 abuts against the cooperating rocker arm 14 to rotate, the cooperating rocker arm 14 is switched from the locked state to the unlocked state, the cooperating rocker arm 14 abuts against the push rod 12 to rotate, and the push rod 12 abuts against the locking arm to rotate such that the latch is disengaged from the locking arm, thereby unlocking the vehicle door.

When the connecting post 312 is inserted through the first clearance slot 212 and the first elongated hole 321, the first rocker arm 21 is driven to rotate, the fixed connection between the first rocker arm 21 and the connecting arm 32 is released, the first rocker arm 21 and the connecting arm 32 move independently, the connecting arm 32 does not rotate relative to the first rocker arm 21, the cooperating rocker arm 14 is kept in the locked state, the cooperating rocker arm 14 does not rotate, and the vehicle door remains locked.

As shown in FIG. 1 and FIG. 2, the vehicle door lock 100 further comprises a toggle 34, the toggle 34 has a sheet-like structure, the toggle 34 is arranged on a side of the sliding member 31 away from the connecting arm 32, and the toggle 34 is slidably and rotatably connected with the sliding member 31. The toggle 34 is configured to drive the sliding member 31 to move such that the connecting post 312 moves into the first driving slot 211 or the first clearance slot 212.

Specifically, one of the sliding member 31 and the toggle 34 is provided with a sliding slot 313, and the other is provided with a sliding post 341, the sliding post 341 passes through the sliding slot 313 and can slide in the sliding slot 313. The toggle 34 is configured to drive the sliding member 31 to move such that the connecting post 312 of the sliding member 31 moves into the first driving slot 211 or the first clearance slot 212. In this embodiment, the sliding slot 313 is formed in the sliding member 31 and the sliding slot 313 penetrates through the sliding member 31. The sliding post 341 is arranged on the toggle 34, the sliding post 341 passes through the sliding slot 313 and can slide in the sliding slot 313, and the sliding post 341 drives the sliding member 31 to move such that the connecting post 312 of the sliding member 31 moves into the first driving slot 211 or the first clearance slot 212. The sliding slot 313 can also be formed on the surface of the sliding member 31 facing the toggle 34 and the sliding groove 313 does not extend through the sliding member 31, which can also realize that the sliding post 341 passes through the sliding slot 313 and can slide in the sliding slot 313. In other embodiments, the sliding slot 313 is formed in the sliding member 31 and the sliding slot 313 penetrates through the sliding member 31, which can also achieve the same effect.

The vehicle door lock 100 provided by the present disclosure can also be used as a child lock for the rear door. When the user turns the toggle 34, the toggle 34 is configured to drive the sliding member 31 to move, the connecting post 312 moves into the first clearance slot 212, and the child lock is engaged. Additionally, when the connecting post 312 moves into the first driving slot 211, the child lock is disengaged.

When the child lock is engaged, the user drives the inner opening handle to rotate, the inner opening handle drives the inner opening rocker arm 35 to rotate, the inner opening rocker arm 35 abuts against the first rocker arm 21 and drives the first rocker arm 21 to rotate, the first rocker arm 21 and the connecting arm 32 move independently, the connecting arm 32 does not rotate relative to the first rocker arm 21, the cooperating rocker arm 14 does not rotate, the cooperating rocker arm 14 is kept in the locked state, and the user cannot open the vehicle door by driving the inner opening handle.

When the child lock is disengaged, the user drives the inner opening handle to rotate, the inner opening handle drives the inner opening rocker arm 35 to rotate, the inner opening rocker arm 35 abuts against the first rocker arm 21 and drives the first rocker arm 21 to rotate, the first rocker arm 21 drives the connecting arm 32 to rotate via the connecting post 312 of the sliding member 31, the connecting arm 32 abuts against the cooperating rocker arm 14, and the cooperating rocker arm 14 is switched from the locked state to the unlocked state, thereby opening the vehicle door. During driving, the child lock can prevent passengers from opening the door by mistake and protect the safety of passengers.

FIG. 5 is a three-dimensional exploded schematic diagram of a vehicle door lock in an embodiment of the present disclosure. In some embodiments, as shown in FIG. 2 and FIG. 5, the vehicle door lock 100 further comprises a second rocker arm 22, a locking pin 23 and a locking linkage 24, the second rocker arm 22 is arranged on a side of the first rocker arm 21 away from the connecting arm 32, and the locking pin 23 is rotatably and slidably connected between the first rocker arm 21 and the second rocker arm 22.

The first rocker arm 21 is further provided with a second driving slot 214 and a second clearance slot 215, the second driving slot 214 and the second clearance slot 215 are spaced apart from the first driving slot 211 and the first clearance slot 212, and the first locking part 231 of the locking pin 23 can pass through the second driving slot 214 and the second clearance slot 215. The second driving slot 214 and the second clearance slot 215 extend through the first rocker arm 21, and the second driving slot 214 and the second clearance slot 215 communicate with each other. The second driving slot 214 and the second clearance slot 215 are L-shaped, and the second driving slot 214 is arranged below the second clearance slot 215. Alternatively, the second driving slot 214 can also be arranged above the second clearance slot 215, which is not limited here. The edge joint of the second driving slot 214 and the second clearance slot 215 is a smooth transition to facilitate the smooth sliding of the first locking part 231 between the second driving slot 214 and the second clearance slot 215. In other embodiments, the second driving slot 214 and the second clearance slot 215 are formed on a side wall of the first rocker arm 21 facing the second rocker arm 22, and the second driving slot 214 and the second clearance slot 215 do not extend through the first rocker arm 21, which can also realize the sliding connection of the locking pin 23 with the first rocker arm 21.

The second rocker arm 22 is provided with a second elongated hole 221, the second elongated hole 221 penetrates through the second rocker arm 22, a second locking part 232 of the locking pin 23 can pass through the second elongated hole 221, and the locking pin 23 can move along the long axis of the second elongated hole 221.

The locking pin 23 comprises a first locking part 231 and a second locking part 232 arranged at opposite ends thereof, and a connecting part 234 connected between the first locking part 231 and the second locking part 232. The first locking part 231, the second locking part 232 and the connecting part 234 are integrally formed. The connecting part 234 is clamped between the first rocker arm 21 and the second rocker arm 22, the first locking part 231, the second locking part 232 and the connecting part 234 are cylindrical, and the radial dimension of the connecting part 234 is larger than that of the first locking part 231 and the second locking part 232. The locking pin 23 can slide along the direction perpendicular to the thickness direction of the first rocker arm 21 and the second rocker arm 22, but cannot move along the thickness direction of the first rocker arm 21 and the second rocker arm 22.

The locking linkage 24 comprises a first linkage 241 and a second linkage 242. The first linkage 241 and the second linkage 242 are fixedly connected, the first linkage 241 is configured to abut against the second rocker arm 22, the second linkage 242 is provided with a connecting slot 240, the linkage structure 11 passes through the connecting slot 240, and the second linkage 242 is configured to drive the linkage structure 11 to rotate so as to switch the linkage structure 11 to the unlocked position or the locked position.

When the first locking part 231 of the locking pin 23 passes through the second driving slot 214, the first rocker arm 21 is fixedly connected to the second rocker arm 22, the first rocker arm 21 drives the second rocker arm 22 to rotate via the locking pin 23, the second rocker arm 22 abuts against the first linkage 241 of the locking linkage 24 to rotate, and the locking linkage 24 is in the unlocked position. Then the first rocker arm 21 is driven again, the first rocker arm 21 drives the connecting arm 32 to rotate, the connecting arm 32 abuts against the cooperating rocker arm 14 and drives the cooperating rocker arm 14 to rotate, thereby opening the vehicle door.

When the first locking part 231 of the locking pin 23 passes through the second clearance slot 215, the fixed connection between the first rocker arm 21 and the second rocker arm 22 is released, that is, the first rocker arm 21 and the second rocker arm 22 move independently. When the first rocker arm 21 is driven, the second rocker arm 22 does not rotate, the locking linkage 24 is not driven by external force, the locking linkage 24 is still in the locked position, and the user cannot open the vehicle door by driving the inner opening handle or the outer opening handle.

The vehicle door lock 100 provided by the present disclosure can also be used as a child lock and a central control lock for the rear door.

When the central control lock and the child lock are engaged, the user drives the inner opening handle to rotate for the first time, the inner opening handle drives the inner opening rocker arm 35 to rotate, the inner opening rocker arm 35 abuts against the first rocker arm 21 and drives the first rocker arm 21 to rotate, the first rocker arm 21 drives the second rocker arm 22 to rotate, the second rocker arm 22 drives the locking linkage 24 to rotate, and the locking linkage 24 is in the unlocked position. At the same time, the first rocker arm 21 and the connecting arm 32 move independently, the connecting arm 32 does not transmit to the cooperating rocker arm 14, the cooperating rocker arm 14 is kept in the locked state, and the user cannot open the vehicle door by driving the inner opening handle. At this time, the locking linkage 24 is in the unlocked position, and the user can open the vehicle door by driving the outer opening handle.

When the central control lock is engaged and the child lock is disengaged, the user drives the inner opening handle to rotate for the first time, the inner opening handle drives the inner opening rocker arm 35 to rotate, the inner opening rocker arm 35 abuts against the first rocker arm 21 and drives the first rocker arm 21 to rotate, the first rocker arm 21 drives the second rocker arm 22 to rotate, the second rocker arm 22 drives the locking linkage 24 to rotate, and the locking linkage 24 is in the unlocked position. At the same time, the first rocker arm 21 drives the connecting arm 32 to rotate via the connecting post 312 of the sliding member 31, the connecting arm 32 abuts against the cooperating rocker arm 14, and the cooperating rocker arm 14 is switched from the locked state to the unlocked state, thereby opening the vehicle door.

While the vehicle is in motion, the child lock is engaged, and the vehicle door cannot be opened by driving the inner opening handle so as to protect the safety of children. If the vehicle is powered off due to a car accident during driving, the locking linkage 24 can be in the unlocked position by driving the inner opening handle, and the user can open the vehicle door by driving the outer opening handle so that the passengers can quickly evacuate from the vehicle.

In some embodiments, the vehicle door lock 100 further comprises a first drive assembly 40, the first drive assembly 40 is configured to drive the locking pin 23 to move into the second driving slot 214 or the second clearance slot 215.

The first drive assembly 40 comprises a first drive member 41, a first transmission member 42 and a lock body slider 43, the first transmission member 42 is rotatably connected between the first drive member 41 and the lock body slider 43, the lock body slider 43 is rotatably and slidably connected with the locking pin 23, and the locking pin 23 can pass through the lock body slider 43. The output end of the first drive member 41 is rotatably connected with the input end of the first transmission member 42, the output end of the first transmission member 42 is rotatably connected with the input end of the lock body slider 43, and the locking pin 23 passes through the lock body slider 43. When the first drive member 41 is actuated, the first drive member 41 drives the first transmission member 42 to rotate, the first transmission member 42 drives the lock body slider 43 to move, and the lock body slider 43 drives the locking pin 23 to move into the second driving slot 214 or the second clearance slot 215.

In one embodiment, the first drive member 41 comprises a first motor 411 and a first worm 412, the first worm 412 passes through the rotating shaft of the first motor 411, the first transmission member 42 comprises a first rack part 421, the first rack part 421 meshes with the first worm 412, and the first rack part 421 is arranged on at least part of the outer peripheral wall of the first transmission member 42. Additionally, the first rack part 421 comprises a plurality of circumferentially arranged helical teeth, with the plurality of helical teeth meshing with the first worm 412.

The first transmission member 42 is provided with a positioning slot, and the lock body slider 43 is provided with a positioning post, and the positioning post is inserted into the positioning slot such that the first transmission member 42 is rotatably connected with the lock body slider 43. Alternatively, the first transmission member 42 can also be provided with a positioning post, and the lock body slider 43 can be provided with a positioning slot, and the positioning post is inserted into the positioning slot such that the first transmission member 42 is rotatably connected with the lock body slider 43.

The lock body slider 43 is provided with a plurality of limiting convex strips on a side facing away from the second rocker arm 22, the plurality of limiting convex strips are slidably connected with the vehicle door or the outer housing, and the limiting convex strips are configured to limit the rotation of the lock body slider 43. However, the lock body slider 43 has the freedom to move along the long axis direction of the elongated hole 221. The lock body slider 43 is provided with a sliding chute 431, the sliding chute 431 penetrates the lock body slider 43, the second locking part 232 of the locking pin 23 can pass through the sliding chute 431, and the upward or downward sliding of the lock body slider 43 can drive the locking pin 23 to move. Alternatively, the sliding chute 431 can also be formed on a side of the lock body slider 43 facing the first rocker arm 21, and the sliding chute 431 does not extend through the lock body slider 43, which can also achieve the same effect.

The first worm 412 of the first drive member 41 meshes with the first rack part 421 of the first transmission member 42, the positioning post of the first transmission member 42 is inserted into the positioning slot of the lock body slider 43, the first transmission member 42 is rotatably connected with the lock body slider 43, and the second locking part 232 of the locking pin 23 is inserted into the sliding chute 431 of the lock body slider 43. When the first motor 411 is actuated, the first worm 412 rotates, the first worm 412 drives the first rack part 421 of the first transmission member 42 to rotate, the first transmission member 42 drives the lock body slider 43 to move, and the lock body slider 43 drives the locking pin 23 to move. Therefore, by controlling the forward and reverse rotation of the first motor 411, the locking pin 23 moves into the second driving slot 214 or the second clearance slot 215.

In other embodiments, the lock body slider 43 can be omitted, and the locking pin 23 is directly clamped in the first transmission member 42, that is, the first transmission member 42 rotates to directly drive the locking pin 23 to move. The lock body slider 43 and the first transmission member 42 can also be omitted, that is, the first drive member 41 is directly connected to the locking pin 23 to drive the locking pin 23 to move via the first drive member 41.

In some embodiments, the vehicle door lock 100 further comprises a second drive assembly 50. The second drive assembly 50 is configured to drive the locking linkage 24 to switch between the unlocked position and the locked position. The second drive assembly 50 further comprises a second drive member 51 and a second transmission member 52, the second drive member 51 is rotatably connected with the second transmission member 52, the second transmission member 52 is fixedly connected to the locking linkage 24, and the second transmission member 52 and the locking linkage 24 are integrally designed. The output end of the second drive member 51 is rotatably connected with the input end of the second transmission member 52, the second drive member 51 drives the second transmission member 52 and the locking linkage 24 to rotate together, and the locking linkage 24 switches between the unlocked position and the locked position.

In one embodiment, the second drive member 51 comprises a second motor 511 and a second worm 512, the second worm 512 passes through the rotating shaft of the second motor 511, the second transmission member 52 comprises a second rack part 521, the second rack part 521 meshes with the second worm 512, and the second rack part 521 is arranged on at least part of the outer peripheral wall of the second transmission member 52. Additionally, the second rack part 521 comprises a plurality of circumferentially arranged helical teeth, with the plurality of helical teeth meshing with the second worm 512.

The second motor 511 of the second drive member 51 drives the second worm 512 to rotate, and the second worm 512 drives the second transmission member 52 and the locking linkage 24 to rotate together. By controlling the forward and reverse rotation of the second motor 511, the locking pin 23 moves into the second driving slot 214 or the second clearance slot 215. When the second transmission member 52 drives the locking linkage 24 and the second transmission member 52 to rotate clockwise together, the locking linkage 24 is in the locked position. When the locking linkage 24 and the second transmission member 52 rotate counterclockwise together, the locking linkage 24 is in the unlocked position.

In other embodiments, the second transmission member 52 can be omitted, that is, the second drive member 51 directly drives the locking linkage 24 to move.

The vehicle door lock 100 provided by the present disclosure can also be used as a super lock and a central control lock for the rear door of the vehicle. Specifically, after the user leaves the vehicle, the user presses the lock button in the vehicle key for the first time, the lock button can drive the second motor 511 of the second drive member 51 to rotate, the second motor 511 drives the second worm 512 to rotate, the second worm 512 drives the second transmission member 52 and the locking linkage 24 to rotate clockwise, the locking linkage 24 is in the locked position, and the central control lock is engaged. The user presses the lock button in the vehicle key again, the lock button can drive the first motor 411 of the first drive member 41 to rotate, and the first motor 411 drives the first worm 412 to rotate. Additionally, when the first worm 412 drives the first transmission member 42 to move clockwise, the first transmission member 42 drives the lock body slider 43 to slide upward, the lock body slider 43 drives the locking pin 23 to slide upward, the locking pin 23 passes through the second clearance slot 215, and the super lock is engaged. When the super lock is engaged, the user cannot open the vehicle door by driving the inner opening handle or the outer opening handle.

When the user presses the unlock button in the vehicle key, the unlock button drives the first motor 411 of the first drive member 41 to rotate, and the first motor 411 drives the first worm 412 to rotate. When the first worm 412 drives the first transmission member 42 to move counterclockwise, the first transmission member 42 drives the lock body slider 43 to slide downward, the lock body slider 43 drives the locking pin 23 to slide downward, the locking pin 23 passes through the second driving slot 214, and the super lock is disengaged. At the same time, the unlock button drives the second motor 511 of the second drive member 51 to rotate, the second motor 511 drives the second worm 512 to rotate, the second worm 512 drives the second transmission member 52 and the locking linkage 24 to rotate counterclockwise, the locking linkage 24 is in the unlocked position, and the central control lock is disengaged such that the user can open the vehicle door by driving the inner opening handle and the outer opening handle.

In some embodiments, as shown in FIG. 5, the vehicle door lock 100 further comprises an outer housing, the outer housing comprises a first housing 61 and a second housing 63 that can be butt-jointed with each other. The inner wall of the first housing 61 is provided with a first connecting shaft 611, the first connecting shaft 611 is configured to pass through the first rocker arm 21, the second rocker arm 22, the connecting arm 32 and the sliding member 31. The sliding member 31 is provided with an elongated hole, the elongated hole is configured for the first connecting shaft 611 to pass through, and the sliding member 31 can move along the long axis direction of the elongated hole so as to facilitate the movement of the connecting post of the sliding member 31 in the first driving slot 211 or the first clearance slot 212. The inner wall of the first housing 61 is provided with a second connecting shaft 612, the second connecting shaft 612 passes through the first transmission member 42, and the first transmission member 42 rotates around the second connecting shaft 612. The inner wall of the first housing 61 is provided with a third connecting shaft 613, the third connecting shaft 613 passes through the inner opening rocker arm 35, and the inner opening rocker arm 35 rotates around the third connecting shaft 613. The inner wall of the first housing 61 is provided with a fourth connecting shaft 614, the fourth connecting shaft 614 passes through the second transmission member 52, and the second transmission member 52 and the locking linkage 24 rotate around the fourth connecting shaft 614 together. The first housing 61 is further provided with a first fixing slot 616, and the first drive member 41 is accommodated and fixed in the first fixing slot 616. The first housing 61 is further provided with a second fixing slot 617, and the second drive member 51 is accommodated and fixed in the second fixing slot 617. The inner wall of the first housing 61 is also provided with a limiting slot corresponding to the limiting convex strip of the lock body slider 43, and the lock body slider 43 slides upward or downward along the limiting slot.

The complete movement process of the vehicle door lock 100 will be described in detail below. It should be understood that the vehicle key comprises an unlock button and a lock button. When the lock button is pressed for the first time, the central control lock is engaged; when the lock button is pressed for the second time, the super lock is engaged. When the unlock button is pressed, both the super lock and the central control lock are disengaged. The rear door of the vehicle is provided with a child lock button, and the child lock button is connected to the toggle 34.

The movement process for disengaging the central control lock is as follows. The unlock button of the vehicle key is pressed, the unlock button drives the second motor 511 to start, and the second motor 511 drives the second worm 512 to rotate. When the second worm 512 drives the second transmission member 52 and the locking linkage 24 to move counterclockwise, the locking linkage 24 drives the linkage structure 11 to move rightward, the locking linkage 24 is in the unlocked position, and the central control lock is disengaged.

When the central control lock is disengaged, the movement process for opening the vehicle door is as follows. The inner opening handle drives the inner opening rocker arm 35 to rotate counterclockwise, the inner opening rocker arm 35 abuts against the first rocker arm 21, the inner opening rocker arm 35 drives the first rocker arm 21 to rotate clockwise, and the first rocker arm 21 abuts against the cooperating rocker arm 14 to open the vehicle door.

The movement process for engaging the central control lock is as follows. The lock button of the vehicle key is pressed, the lock button drives the second motor 511 to start, and the second motor 511 drives the second worm 512 to rotate. When the second worm 512 drives the second transmission member 52 and the locking linkage 24 to move clockwise, the locking linkage 24 is in the locked position, and the central control lock is engaged.

When the central control lock is engaged, the movement process for opening the vehicle door is as follows. There are two ways to open the vehicle door, first, the inner opening handle is driven for the first time, the inner opening handle drives the inner opening rocker arm 35 to rotate counterclockwise, the inner opening rocker arm 35 drives the first rocker arm 21 to rotate clockwise, the first rocker arm 21 drives the second rocker arm 22 to rotate clockwise via the locking pin 23, the second rocker arm 22 drives the locking linkage 24 to rotate counterclockwise, and the locking linkage 24 is in the unlocked position. Then, the inner opening handle is driven for the second time, the inner opening handle drives the inner opening rocker arm 35 to rotate counterclockwise, the inner opening rocker arm 35 abuts against the first rocker arm 21, the inner opening rocker arm 35 drives the first rocker arm 21 to rotate counterclockwise, and the first rocker arm 21 abuts against the cooperating rocker arm 14 to open the vehicle door. In other words, the vehicle door can be opened by pulling the inner opening handle twice. Second, the unlock button of the vehicle key is pressed, the unlock button drives the second drive member 51 to reverse such that the locking linkage 24 is in the unlocked position, and the vehicle door can be opened directly by driving the inner opening handle or the outer opening handle.

The movement process for disengaging the child lock is as follows. The child lock button is driven, the child lock button drives the toggle 34 to rotate counterclockwise, the toggle 34 is configured to drive the sliding member 31 to move upward, the connecting post 312 moves into the first driving slot 211, and the child lock is disengaged.

When the child lock is disengaged, the movement process for opening the vehicle door is as follows. The inner opening handle is driven, the inner opening handle drives the inner opening rocker arm 35 to rotate counterclockwise, the inner opening rocker arm 35 abuts against the first rocker arm 21 and drives the first rocker arm 21 to rotate clockwise, the first rocker arm 21 drives the connecting arm 32 to rotate clockwise via the connecting post 312 of the sliding member 31, the connecting arm 32 drives the cooperating rocker arm 14 to rotate, thereby opening the vehicle door.

The movement process for engaging the child lock is as follows. The child lock button is driven, the child lock button drives the toggle 34 to rotate clockwise, the toggle 34 is configured to drive the sliding member 31 to move downward, the connecting post 312 moves into the first clearance slot 212, and the child lock is engaged.

When the child lock is engaged, the movement process for opening the vehicle door is as follows. The inner opening handle is driven, the inner opening handle drives the inner opening rocker arm 35 to rotate counterclockwise, the inner opening rocker arm 35 drives the first rocker arm 21 to rotate clockwise, the first rocker arm 21 drives the second rocker arm 22 to rotate clockwise via the locking pin 23, the second rocker arm 22 drives the locking linkage 24 to rotate counterclockwise, the locking linkage 24 is in the unlocked position, and the central control lock is disengaged. The inner opening handle is driven again, the inner opening handle drives the inner opening rocker arm 35 to rotate counterclockwise, the inner opening rocker arm 35 abuts against and drives the first rocker arm 21 to rotate clockwise, the first rocker arm 21 and the connecting arm 32 move independently, the connecting arm 32 is away from the cooperating rocker arm 14, and the user cannot open the vehicle door by driving the inner opening handle. However, at this time, the central control lock is disengaged, and the vehicle door can be opened by driving the outer opening handle.

The movement process for disengaging the super lock is as follows. The unlock button of the vehicle key is pressed for the first time, the unlock button drives the first motor 411 to start, the first motor 411 drives the first worm 412 to rotate, the first worm 412 drives the first transmission member 42 to move counterclockwise, the first transmission member 42 drives the lock body slider 43 to slide downward, the lock body slider 43 drives the locking pin 23 to slide downward, the locking pin 23 passes through the second driving slot 214, and the super lock is disengaged.

When the central control lock is engaged and the super lock is engaged, the vehicle door cannot be opened by driving the inner opening handle or the outer opening handle, regardless of whether the child lock is engaged or disengaged. The super lock can be used after the vehicle is parked and the driver leaves, the user presses the lock button of the vehicle key to engage the central control lock, and presses the lock button of the vehicle key again to engage the super lock.

When the central control lock is engaged, the super lock is disengaged, and the child lock is engaged, the inner opening handle is driven, the inner opening handle drives the inner opening rocker arm 35 to rotate counterclockwise, the inner opening rocker arm 35 drives the first rocker arm 21 to rotate clockwise, the first rocker arm 21 drives the second rocker arm 22 to rotate clockwise via the locking pin 23, the second rocker arm 22 drives the locking linkage 24 to rotate counterclockwise, the locking linkage 24 is in the unlocked position, and the central control lock is disengaged. The inner opening handle is driven again, the inner opening handle drives the inner opening rocker arm 35 to rotate counterclockwise, the inner opening rocker arm 35 abuts against and drives the first rocker arm 21 to rotate clockwise, the first rocker arm 21 and the connecting arm 32 move independently, the connecting arm 32 is away from the cooperating rocker arm 14, and the user cannot open the vehicle door by driving the inner opening handle. However, at this time, the central control lock is disengaged, and the vehicle door can be opened by driving the outer opening handle. The child lock can be used during driving, the user drives the toggle 34 to rotate clockwise, and the child lock is engaged, which can prevent passengers in the vehicle from opening the door by mistake.

In the description of the embodiments of the present disclosure, it should be noted that the orientation or positional relationship indicated by the terms “center”, “upper”, “lower”, “left”, “right”, “vertical”, “horizontal”, “inner”, “outer”, etc. is based on the orientation or positional relationship shown in the accompanying drawings, this is only for the convenience of describing the present disclosure and simplifying the description, but does not indicate or imply that the referred device or element must have a specific orientation, be constructed and operated in a specific orientation. Thus, it should not be construed as limiting the present disclosure.

The above descriptions are merely some embodiments of the present disclosure, and of course, they cannot be used to limit the scope of the claims of the present disclosure. A person skilled in the art will appreciate that all or part of the processes of implementing the foregoing embodiments, and any equivalent modifications made in accordance with the claims of the present disclosure shall still fall within the scope encompassed by the present disclosure.

### DESCRIPTION OF REFERENCE NUMERALS

100—vehicle door lock; 11—linkage structure; 12—push rod; 14—cooperating rocker arm; 21—first rocker arm; 211—first driving slot; 212—first clearance slot; 214—second driving slot; 215—second clearance slot; 22—second rocker arm; 221—second elongated hole; 23—locking pin; 231—first locking part; 232—second locking part; 234—connecting part; 24—locking linkage; 241—first linkage; 242—second linkage; 240—connecting slot; 31—sliding member; 311—connecting piece; 312—connecting post; 313—sliding slot; 32—connecting arm; 321—first elongated hole; 34—toggle; 341—sliding post; 35—inner opening rocker arm; 40—first drive assembly; 41—first drive member; 411—first motor; 412—first worm; 42—first transmission member; 421—first rack part; 43—lock body slider; 431—sliding chute; 50—second drive assembly; 51—second drive member; 511—second motor; 512—second worm; 52—second transmission member; 521—second rack part; 61—first housing; 611—first connecting shaft; 612—second connecting shaft; 613—third connecting shaft; 614—fourth connecting shaft; 616—first fixing slot; 617—second fixing slot; 63—second housing

1. A vehicle door lock, comprising: a first rocker arm, a sliding member, a connecting arm, and a cooperating rocker arm; the first rocker arm, the connecting arm and the sliding member being successively stacked; the first rocker arm and the connecting arm being connected via the sliding member
the first rocker arm includes a first driving slot and a first clearance slot, the first driving slot and the first clearance slot communicating with each other; the sliding member includes a connecting post; the cooperating rocker arm including a locked state and an unlocked state;
when the connecting post is inserted through the connecting arm and the first driving slot, the first rocker arm is connected to the connecting arm, and the first rocker arm is configured to drive the connecting arm to rotate via the connecting post, the connecting arm abuts against the cooperating rocker arm, and the cooperating rocker arm is switched from the locked state to the unlocked state;
when the connecting post is inserted through the connecting arm and the first clearance slot, the connection between the first rocker arm and the connecting arm is released such that, when the first rocker arm moves, the cooperating rocker arm is configured to be kept in the locked state.

2. The vehicle door lock (100) according to claim 1, wherein the connecting arm includes a first elongated hole, the first elongated hole penetrates the connecting arm, the connecting post is arranged along the sliding member; while the connecting post moves within a long axis of the first elongated hole, the connecting post simultaneously moves into the first driving slot or the first clearance slot.

3. The vehicle door lock according to claim 1, further comprising: a toggle, the toggle being arranged on a side of the sliding member away from the connecting arm, the toggle being slidably and rotatably connected with the sliding member; the toggle being configured to drive the sliding member to move such that the connecting post moves into the first driving slot or the first clearance slot.

4. The vehicle door lock according to claim 1, further comprising: an inner opening rocker arm, the inner opening rocker arm abutting against the first rocker arm, the inner opening rocker arm being configured to connect to an inner opening handle of a vehicle, wherein the inner opening handle is configured to drive the inner opening rocker arm to rotate such that the inner opening rocker arm drives the first rocker arm to rotate.

5. The vehicle door lock according to claim 1, further comprising: a second rocker arm, a locking pin and a locking linkage, the second rocker arm being arranged on a side of the first rocker arm away from the connecting arm, and the locking pin being rotatably and slidably connected between the first rocker arm and the second rocker arm; the first rocker arm is further provided with a second driving slot and a second clearance slot, the second driving slot and the second clearance slot communicate with each other; the locking linkage being provided with a locked position and an unlocked position;
when the locking pin is inserted between the second driving slot and the second rocker arm, the first rocker arm is connected to the second rocker arm, the first rocker arm is configured to drive the second rocker arm to rotate via the locking pin, the second rocker arm abuts against the locking linkage, and the locking linkage is switched from the locked position to the unlocked position;
when the locking pin is inserted between the second clearance slot and the second rocker arm, the connection between the first rocker arm and the second rocker arm is released such that, when the first rocker arm moves, the locking linkage is configured to be kept in the locked position.

6. The vehicle door lock according to claim 5, wherein the second rocker arm includes a second elongated hole, the locking pin is inserted through the second elongated hole, one end of the locking pin is configured to move along a long axis of the second elongated hole, and the other end of the locking pin moves into the second driving slot or the second clearance slot.

7. The vehicle door lock according to claim 5, further comprising: a first drive assembly, the first drive assembly being configured to drive the locking pin to move into the second driving slot or the second clearance slot.

8. The vehicle door lock according to claim 7, wherein the first drive assembly comprises a first drive member, a first transmission member and a lock body slider, the first transmission member is rotatably connected between the first drive member and the lock body slider, the lock body slider is rotatably and slidably connected with the locking pin, the first drive member is configured to drive the first transmission member to rotate, the rotation of the first transmission member is configured to drive the lock body slider to move, and the lock body slider drives the locking pin to move into the second driving slot or the second clearance slot.

9. The vehicle door lock according to claim 5, further comprising: a second drive assembly, the second drive assembly being configured to drive the locking linkage to switch between the unlocked position and the locked position.

10. The vehicle door lock according to claim 9, wherein the second drive assembly further comprises a second drive member and a second transmission member, the second drive member is rotatably connected with the second transmission member, the second transmission member is connected to the locking linkage, the second drive member is operable to drive the second transmission member and the locking linkage to rotate together such that the locking linkage is operable to switch between the unlocked position and the locked position.

11. A vehicle, comprising: a vehicle door and a vehicle door lock as claimed in claim 1, wherein the vehicle door lock is installed on the vehicle door.
